(19) United States
(12) Patent Application Publication
(10) Pub. No.: US 2004/0040175 A1
(43) Pub. Date: Mar. 4, 2004

(54) Device and method for the drying of plastic webs

(76) Inventor: Franz Starlinger Huemer, Vienna (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/399,349

(22) PCT Filed: Oct. 15, 2001
(86) PCT No.: PCT/AT01/00332

(30) Foreign Application Priority Data
Oct. 17, 2000 (AT) A1777/2000

(51) Int. Cl. F26B 11/02

(52) U.S. Cl. 34/444; 34/114

(57) ABSTRACT

The invention relates to a device and method for the drying of plastic webs. Said device comprises at least one group of nozzles, whereby each group comprises at least two nozzles, between which a gap is provided for the introduction of a plastic web. According to the invention, air streams from each of the nozzles (4,5; 14,15; 24,25) in a group may be directed at the gap (6) in such a way that a plastic web (3) fed through said gap is made to oscillate (at 3a). By means of the vibration of the plastic web, any water droplets (18) found on the web are quickly shaken from the web and the plastic web thus dried.

The invention relates to a device for the drying of plastic webs, comprising at least one group of nozzles, whereby each group comprises at least two nozzles, between which a gap is provided for the introduction of a plastic web. The invention further relates to a method for the drying of plastic webs.

An industrial method for the production of films consists in that plastic material is extruded through a sheet die into a water bath where the plastic material cools down, thereby solidifying to a plastic web. By an appropriate discharge means, the plastic film thus formed is withdrawn from the water bath in order to be subjected to further processing steps such as cutting and stretching. However, before any further processing of the film may take place; it must be dried completely. According to the prior art that is achieved in that, downstream of the discharge means, suction nozzles are arranged on both main sides of the film web, which suction nozzles suck off any water sticking to the film when the film is transported between the suction nozzles. However, said drying process requires that the film has a relatively long retention time in the suction portion, or in other words, it allows only a low transport speed of the film between the suction nozzles in order to ensure complete drying of the film. Hence, in the industrial manufacture of plastic films or the products produced therefrom, such as stretched plastic bands, the drying process represents a ,,bottleneck” with regard to the manufacturing speed that is achievable, which bottleneck may only be alleviated by an appropriate multiplication of the suction nozzles and, in connection therewith, a multiplication of the capacity of the devices for creating the necessary vacuum. However, that involves an expensive and impracticable enlargement of the entire plant.

From the printing technology, in particular with rotary presses, it also is known to blow hot air onto one or both sides of the paper webs in order to dry the printing ink. However, in the field of the manufacture of plastic films, drying by hot air is generally not a convenient solution, since high temperatures and/or long retention times are necessary in order to attain a sufficient effect, and that would soften the plastic material just solidified in the water bath. That in turn would deteriorate the film product in an unacceptable manner as the films is subject to tensile stress when being discharged from the water bath, which tensile stress, in connection with the, unavoidable softening, might lead to stretching of the film or even to a rupture of the same due to the effects of heat.

The invention has as its object to eliminate the above mentioned problems occurring during the drying of plastic films or to decrease them at least. That object is achieved by means of a novel device and a method for the drying of plastic webs, wherein the device for the drying of plastic webs comprises at least one group of nozzles, whereby each group comprises at least two nozzles, between which a gap is provided for the introduction of a plastic web. According to the invention, the air streams from each of the nozzles in a group may now be directed at the gap between them in such a way that a plastic web fed through said gap is made to oscillate. By means of the vibration of the plastic web, any water droplets found on the web are quickly shaken from the web. It is significant to note that, although compressed air from the nozzles is blown onto the plastic web, the effect of drying is based on the water being shaken from the web surface due to the vibration of the web, whereby the evaporation or displacement of water by the stream of nozzle air is not a factor worth mentioning. The device according to the invention enables an extremely fast drying of the plastic web and hence a transport speed of the plastic web through the drying device that is greatly improved in comparison with the state of the art.

A preferred embodiment of the device according to the invention is characterized in that the nozzles comprise nozzle tubes having a plurality of air outlets. Said embodiment is robust and reliable, and the nozzle tubes may be arranged in a large number of different configurations.

It has been shown that a higher amplitude of the oscillations of the plastic web is achievable with the blowing power remaining the same, if the nozzles facing each other in a group of nozzles are mutually offset.

Advantageously, a control device for regulating the air supply to the nozzles is provided so that the nozzles can be driven individually, in groups or jointly, whereby various nozzles can be supplied with air successively or-different predetermined air speed profiles can be generated.

Furthermore, it is advantageous if a tensile stress sensor is provided for evaluating the tensile stress acting on the plastic web. The signals of the tensile stress sensor may be supplied to the above mentioned control system as input parameters and may influence the automatic selection of a specific control program.

The water shaken from the plastic web suitably is collected in runoff plates surrounding the nozzles at least partially. On or below the runoff plates, advantageously suction means are provided which serve for draining the water that has been collected from the drying device.

Since acoustically the oscillating plastic web acts in the manner of a plate oscillator and, correspondingly, generates a high noise level, in a preferred embodiment the nozzles are arranged in a sound-absorbing casing.

The vibration of the plastic web depends on the tension of the web. In order to attain a simple or effective variant of the oscillations, an embodiment of the invention has a device for adjusting the tension of the plastic web in the area of the nozzles, which means' preferably is adjustable during operation.

The invention also relates to a method for the drying of plastic webs, comprising the provision of at least one group of nozzles, whereby each group comprises at least two nozzles, between which a gap is provided for the introduction of a plastic web, the transportation of a plastic web through the gap between the nozzles in a respective group, characterized by the blowing of air onto the plastic web from the nozzles in a respective group so that the plastic web is made to oscillate in the area of the nozzles. By means of that vibration of the plastic web, any water droplets found on the web are quickly shaken from the web, allowing the transport speed of the plastic web through the drying device to be very high, while still achieving complete drying. A particularly great efficiency of the device according to the invention is achieved if the oscillations triggered in the plastic web have a frequency of more than 100 Hz, preferably more than 1 kHz, whereby also frequencies down to the ultrasonic region may advantageously be used. It is assumed that with those high frequencies the adhesion between plastics and water is overcome more easily and that furthermore large water droplets are divided into small droplets.

Advantageously, the air supply to the nozzles is regulated individually, jointly or in groups, preferably by alternately switching on and off compressed air or by following predetermined air speed profiles. In doing so, the control of the nozzles may be effected as a function of the values of a sensor measuring the tensile stress of the plastic web.

The vibration of the plastic web may also be varied by adjusting the tension of the plastic web in the area of the nozzles.

Further features and advantages of the invention are evident from the following detailed description of exemplary embodiments. In the drawings,

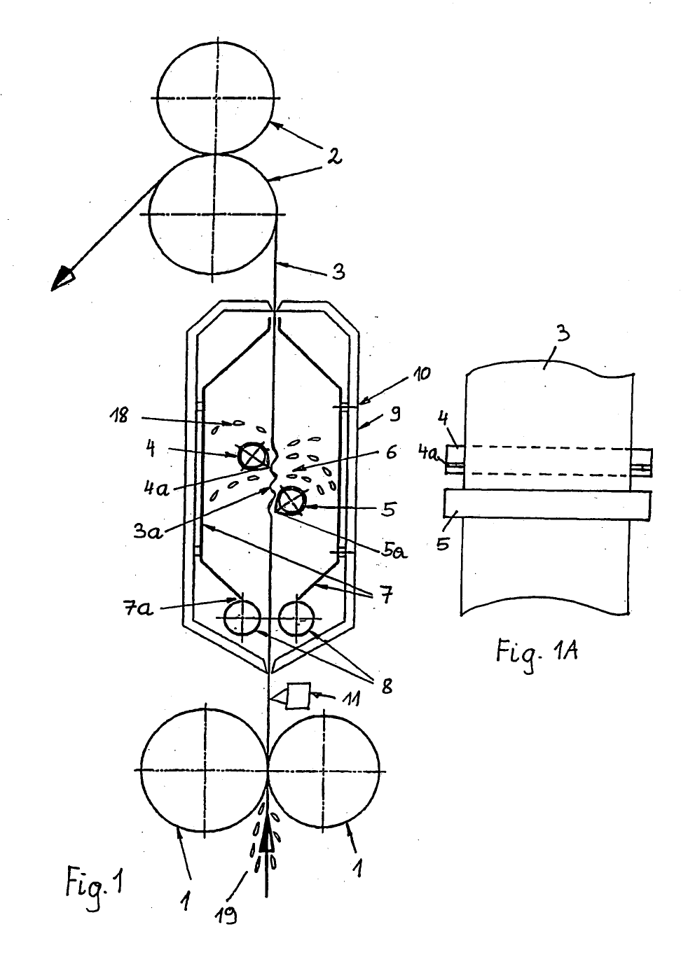

FIG. 1 shows a schematic side view of a preferred embodiment of the invention, FIG. 1A shows a schematic front view of a part of the embodiment of FIG. 1,

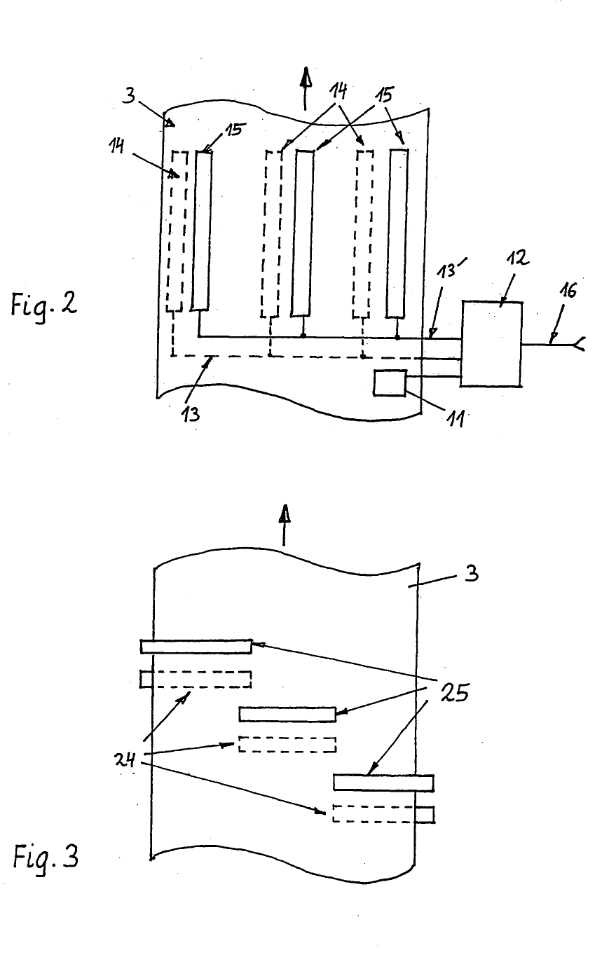

FIGS. 2 and 3 show schematic front views of various other arrangements of the nozzles.

First referring to FIG. 1, which represents a preferred embodiment of the device according to the invention for the drying of plastic webs, a first pair of take-down rollers 1,1 can be seen which withdraw a plastic web 3 wetted by water droplets 19 from the water bath, which plastic web is generated by extruding a plastic material from a sheet die into a water bath, such as known per se—which extrusion is not illustrated in the drawing—where the plastic material solidifies to the film web. Downstream of the first pair of take-down rollers 1,1, there is a second pair of take-down rollers 2,2, which, on the one hand, provides for a predetermined tension of the plastic web 3 between the two pairs of take-down rollers 1,1; 2,2 and, on the other hand, conveys the plastic web 3 to further processing stations such as cutting and stretching means. The device according to the invention for the drying of plastic webs is located between the two pairs of take-down rollers 1,1; 2,2, which device comprise a first tubular nozzle 4 having a plurality of outlets 4a and a second tubular nozzle 5 having a plurality of outlets 5a. The two nozzles are spaced apart such that a distance 6 is defined between them through which the plastic web 3 is conducted. The outlets 4a, 5a of each nozzle 4, 5 are each directed at a respective main side of the plastic web 3. Furthermore, it must be noted that the two nozzles 4, 5 are mutually offset with regard to the conveying direction of the plastic web so that nozzle 4 is located further downstream. That can be seen most clearly in the front view of FIG. 1A, which also shows that the tubular nozzles 4, 5 reach across the entire width of the plastic web 3. For the sake of better clearness, the remaining parts of the embodiment of FIG. 1 were omitted in FIG. 1A. Although in the illustrated embodiment one tubular nozzle is arranged on each of the two main sides of the plastic web, it is clear to a person skilled in the art that also several nozzles can be provided, whereby in each case at least one nozzle on one side of the plastic web forms a group together with at least one nozzle on the other side of the plastic web. Instead of the tubular nozzles with several outlets, also several small nozzles each having one outlet could be provided, which nozzles are arranged in a row or in a suitable pattern.

The nozzles 4, 5 are supplied with compressed air from a source of compressed air (not illustrated) via a control device (not illustrated) in such a manner that section 3a of the plastic web 3 that is conveyed through the nozzles is made to oscillate (vibrate). That may be achieved by a continuous fanning from both sides while taking into account the web tension and the dead weight as well as the rigidity of the plastic web, or by switching the individual nozzles on and off in a time-controlled manner, or by blowing a varying air stream onto the plastic web, whereby different air stream profiles can be adjusted. In an alternative embodiment of the invention, the cross section of the nozzle outlets or the air flow angle relative to the plastic web may be adjusted in order to regulate the stream of nozzle air. By means of the vibrations which are generated by the air nozzles 4, 5 in section 3a of the plastic web, any water found on the web surface is shaken from the web very quickly (illustrated by water droplets 18) and thus the plastic web is dried completely. The water droplets 18 that are shaken off impinge on the runoff plates 7 located behind the nozzles, which runoff plates are bent toward the conveying path of the plastic web 3 in such a manner that at their top and bottom ends, downstream and upstream of the nozzles 4, 5, gaps for the introduction of web 3 remain open. Suction tubes 8 which collect the water running off along the runoff plates and draw it from the drying device are located below the lower edge 7a of the runoff plates 7.

The air stream from the nozzles 4, 5 triggers oscillations in the plastic web which amount to several hundred Hertz, with a particularly good drying efficiency resulting if the oscillation frequency of the plastic web is between 1 kHz and 20 kHz. Depending on the thickness of the plastic web, it might also be suitable to trigger vibrations in the web which are in the ultrasonic region, in that case, however, the inherent temperature rise of the web must be considered. The noise level caused by the vibration during drying is significant, which is why a two-piece casing 9 made of a material with good acoustic insulation is provided outside the runoff plates 7, which casing surrounds the nozzles 4, 5, the runoff plates 7 and the suction tubes 8 and only leaves open narrow slits for the introduction of the plastic web 3. For the purpose of a simple assembly, the runoff plates 7 can be fitted to the inside walls of the casing 9 by means of bolts 10 or the like, whereby a separate installation of the runoff plates 7 becomes superfluous.

As mentioned above, the vibration of the plastic web 3, as far as-its frequency and amplitude is concerned, is also dependent on the tensile stress to which the web is exposed between the pairs of take-down rollers 1,1; 2,2. The tensile stress may be varied by appropriately regulating the drive of at least one of the-pairs of take-down rollers 1,1; 2,2. Furthermore, a tensile stress sensor 11 is provided in the illustrated embodiment, the output signal of which may be used for controlling the pairs of take-down rollers 1,1; 2,2 or the air stream from the nozzles 4, 5. For reasons of clarity, the tensile stress sensor 11 is illustrated as a separate component; in practice, however, it will be incorporated in the shaft or hub of a take-down roller or in the drive of the pairs of take-down rollers.

FIG. 2 shows a schematic front view of an exemplary embodiment of the invention, exhibiting an alternative arrangement of the nozzles. Thereby, three spaced apart tubular nozzles 15 are arranged so as to-have their longitudinal axes in the conveying direction (see arrow) of the plastic web 3. Three further tubular nozzles 14 illustrated in broken lines—and lying below the first group of nozzles comprising nozzles 15 with respect to the level of the drawing sheet—are arranged so as to have their longitudinal axes in the conveying direction of the plastic web 3. The, plastic web 3 is conveyed through nozzles 14 and nozzles 15. Relative to nozzles 15, the nozzles 14 are offset transversely to the conveying direction of the plastic web. One nozzle 14 at a time forms a group of nozzles with an opposite nozzle 15, with a gap for the introduction of the plastic web formed between the nozzles in a group. Via a compressed-air pipe 13; the nozzles 14 are connected to a control device 12 which, via a pipe 16, in turn is connected to a source of compressed air not illustrated further. Via a compressed-air pipe 13′, the nozzles 15 are connected to the control device 12. Furthermore, a tensile stress sensor 11 is connected to the control device 12. The functioning of the control device is equal to what is, explained with regard to FIG. 1. The remaining parts of said embodiment of the device according to the invention for the drying of plastic webs are equal to those of the first embodiment according to FIG. 1 and were omitted in FIG. 2 for reasons of clarity.

FIG. 3 shows a schematic front view of a further exemplary embodiment of the invention with three tubular nozzles 25 being arranged so as to have their longitudinal axes on one level transverse to the conveying direction (see arrow) of the plastic web 3. Three further tubular nozzles 24 illustrated in broken lines—and lying on a level below that of nozzles 15 with respect to the level of the drawing sheet (which may be envisaged as the transport level of the plastic web 3)—are arranged so as to have their longitudinal axes transverse to the conveying direction of the plastic web 3. Relative to nozzles 25, the nozzles 24 are offset in opposition to the conveying direction of the plastic web 3. It is foreseen that the nozzles 24, 25 corresponding with each other are configured in such a way that they can be switched on and off in pairs in order to make sure that plastic webs of various widths can be conveyed between the pairs of nozzles without any manual change to the nozzle configuration.

claims:

1. A device for the drying of plastic webs, comprising at least one group of nozzles, whereby each group comprises at least two nozzles, between which a gap is provided for the introduction of a plastic web, characterized in that air streams from each of the nozzles (4,5; 14,15; 24,25) in a respective group may be directed at the gap (6) in such a way that a plastic web (3) fed through said gap is made to oscillate (at 3a) at such an amplitude and frequency that any liquid found on the surfaces of the plastic web is shaken off.

2. A device according to claim 1, characterized in that the nozzles comprise nozzle tubes (4, 5) having a plurality of air outlets (4a, 5a).

3. A device according to claim 1 or 2, characterized in that the nozzles (4,5; 14,15; 24,25) facing each other in a group of nozzles are mutually offset.

4. A device according to any of the preceding claims, characterized in that a control device (12) for regulating the air supply to the nozzles is provided.

5. A device according to claim 4, characterized in that a tensile stress sensor (11) for evaluating the tensile stress acting on the plastic web (3) is provided.

6. A device according to any of the preceding claims, characterized in that the nozzles (4, 5) each are at least partially surrounded by runoff plates (7).

7. A device according to claim 6, characterized in that suction means (8) are provided on or below the runoff plates (7).

8. A device according to any of the preceding claims, characterized in that the nozzles (4, 5) are arranged in a sound-absorbing casing (9).

9. A device according to any of the preceding claims, characterized in that a device for adjusting the tension of the plastic web in the area of the nozzles, preferably comprising at least one pair of take-down rollers (1,1; 2,2), which means preferably is adjustable during operation, is provided.

10. A method for the drying of plastic webs, comprising
the provision of at least one group of nozzles (4,5; 14,15; 24,25), whereby each group comprises at least two nozzles, between which a gap (6) is provided for the introduction of a plastic web (3),
the transportation of a plastic web through the gap (6) between the nozzles in a respective group,
characterized by the blowing of air onto the plastic web (3) from the nozzles in a respective group so that the plastic web (3) is made to oscillate in the area (3a) of the groups of nozzles at such an amplitude and frequency that any liquid found on the surfaces-of the plastic web is shaken off.

11. A method according to claim 10, characterized in that the oscillations triggered in the plastic web (3) have a frequency of more than 100 Hz, preferably-more than 1 kHz.

12. A method according to claim 10 or 11, characterized in that the air supply to the nozzles (4,5; 14,15; 24,25) is regulated individually, jointly or in groups, preferably by alternately switching on and off compressed air or by following predetermined air speed profiles.

13. A method according to claim 12, characterized in that the control of the nozzles is effected as a function of the values of a sensor (11) measuring the tensile stress of the plastic web.

14. A method according to any of claims 10 to 12, characterized in that the tension of the plastic web (3) can be adjusted in the area of the nozzles.
